(19) United States
(12) Patent Application Publication
(10) Pub. No.: US 2023/0245689 A1
(43) Pub. Date: Aug. 3, 2023

(54) SYSTEM AND METHOD FOR AUTOMATICALLY CREATING TRANSITION VIDEOS

(71) Applicants: LAKSHMINATH REDDY DONDETI, San Jose, CA (US); VIDYA NARAYANAN, San Jose, CA (US)

(72) Inventors: LAKSHMINATH REDDY DONDETI, San Jose, CA (US); VIDYA NARAYANAN, San Jose, CA (US)

(21) Appl. No.: 18/093,338

(22) Filed: Jan. 5, 2023

Related U.S. Application Data
(60) Provisional application No. 63/305,351, filed on Feb. 1, 2022.

(51) Int. Cl. G11B 27/34; G06V 20/40; G06F 16/683

(52) U.S. Cl. CPC G11B 27/34; G06V 20/46; G06F 16/683

(57) ABSTRACT

Exemplary embodiments of the present disclosure are directed towards system and method for automatically creating transition videos comprising computing device comprising video creating module configured to allow user to select music track from music tracks, thereby transferring user selected music track to server. Server comprising automated transitions creating module configured to receive user selected music track and perform audio analysis to detect inflection points, assign transition points to user selected music track based on detected inflection points. Automated transitions creating module configured to generate start and stop points corresponding to transition points on music track and transfer music track with start and stop points to computing device. Video creating module configured to enable user to record video segments at start and stop points of music track, thereby transferring user recorded video segments to server, automated transitions creating module configured to create transition video by synchronizing user recorded video segments.

### CROSS-REFERENCE TO RELATED APPLICATIONS

This patent application claims priority benefit of U.S. Provisional Patent Application No. 63/305,351, entitled “METHOD AND APPARATUS FOR AUTOMATICALLY CREATING TRANSITION VIDEOS WITHOUT COMPLEX EDITING”, filed on 1 Feb. 2022. The entire contents of the patent application are hereby incorporated by reference herein in its entirety.

### COPYRIGHT AND TRADEMARK NOTICE

This application includes material which is subject or may be subject to copyright and/or trademark protection. The copyright and trademark owner(s) have no objection to the facsimile reproduction by any of the patent disclosure, as it appears in the Patent and Trademark Office files or records, but otherwise reserves all copyright and trademark rights whatsoever.

### TECHNICAL FIELD

The present invention relates to automatically detecting inflection points in a music track and enabling transitions at those spots, thereby creating a transition video. Secondly, it relates to being able to automatically stop recording the video at the identified transition points of the music track so that a user may continue recording the video in hands-free mode. Lastly, it relates to marking the inflection points in the music track and making a marked-up version of the music track to create automated transition videos.

### BACKGROUND

Nowadays, video posting and sharing are growing over digital platforms, and users share their memories and events of life with friends around the world. With the propagation of digital cameras and mobile devices, users have more digital content to share on digital platforms. So, there is a massive amount of need for users to edit videos. Video transition effects are widely used in video editing to connect shots for creating cohesive and visually appealing videos. However, it is challenging for non-professionals to choose the best transitions due to the lack of cinematographic knowledge and design skills.

There are some existing editing tools to assist with video editing. However, their primary target users are professionals, while novices may find it challenging to learn. Moreover, they still lack the ability to automatically video edit. Also, many of these editing tools require manual video editing. The main problem with manual video editing today is that it requires a massive amount of work from the user: the user must record each segment, then edit each segment to a level where a smooth transition is achieved in the resulting video. These edits may include cropping a portion of the video from each segment at the end or the beginning, aligning the body frames between the different segments, and resizing the body frames as needed to achieve alignment. Unless positioned accurately to use the same distance and angle from the camera, perfect alignment may not be achieved using these techniques.

In the light of the aforementioned discussion, there exists a need for a certain system and method for automatically creating transition videos with novel methodologies that would overcome the above-mentioned challenges.

### SUMMARY

The following invention presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

An objective of the present disclosure is directed towards a system and method for automatically creating transition videos.

Another objective of the present disclosure is directed towards enabling a user to create or record videos on a computing device to create automated transition videos.

Another objective of the present disclosure is directed towards enabling the user to upload offline recorded videos on the computing device to create automated transition videos.

Another objective of the present disclosure is directed towards enabling the user to create transition videos with far less effort.

Another objective of the present disclosure is directed towards enabling the user to select a music track on the computing device to create automated transition videos.

Another objective of the present disclosure is directed towards a system that detects inflection points in the music track.

Another objective of the present disclosure is directed towards a system that enables transitions at the inflection points.

Another objective of the present disclosure is directed towards a system that provides start and stops points corresponding to the transition points on the music track to create automated transition videos.

Another objective of the present disclosure is directed towards a system that automatically stops recording the video at the identified transition points of the music track.

Another objective of the present disclosure is directed towards a system that enables the user to record the video in hands-free mode.

Another objective of the present disclosure is directed towards a system that removes the need to crop any unnecessary aspects.

Another objective of the present disclosure is directed towards a system that organizes the music tracks to mark specific points for transitions.

Another objective of the present disclosure is directed towards a system that allows the user to mark their custom transition points on the audio track before recording the transition videos.

Another objective of the present disclosure is directed towards a system that allows the user to mark their custom transition points on the audio track after recording the video.

Another objective of the present disclosure is directed towards a system that automatically generates different types of transitions, for example, a change of attire, and this may be about going from standing to sitting or vice-versa, going from jumping up to returning down on the jump, and so on.

According to an exemplary aspect of the present disclosure, a computing device configured to establish communication with a server over a network.

According to another exemplary aspect of the present disclosure, the computing device comprises a video creating module configured to enable a user to access a special icon.

According to another exemplary aspect of the present disclosure, redirecting the user to a track screen and displaying one or more music tracks to the user on the track screen.

According to another exemplary aspect of the present disclosure, allow the user to access and select a music track from the one or more music tracks.

According to another exemplary aspect of the present disclosure, transfer the user selected music track to a server over a network.

According to another exemplary aspect of the present disclosure, the server comprises an automated transitions creating module configured to receive the user selected music track.

According to another exemplary aspect of the present disclosure, the transitions creating module configured to perform audio analysis on the user selected music track and detect one or more inflection points.

According to another exemplary aspect of the present disclosure, assigning one or more transition points to the user selected music track based on the one or more detected inflection points.

According to another exemplary aspect of the present disclosure, the automated transitions creating module configured to generate one or more start and stop points corresponding to the one or more transition points on the user selected music track and transfer the user selected music track with the one or more start and stop points to the computing device over the network.

According to another exemplary aspect of the present disclosure, the video creating module configured to receive the user selected music track with the one or more start and stop points and display the one or more start and stop points of the music track to the user on the computing device.

According to another exemplary aspect of the present disclosure, the video creating module is configured to enable the user to record one or more video segments at the music track's start and stop points.

According to another exemplary aspect of the present disclosure, the video creating module configured to transfer the user recorded one or more video segments to the server.

According to another exemplary aspect of the present disclosure, the automated transitions creating module configured to receive the user recorded one or more video segments and create a transition video by synchronizing the user recorded one or more video segments.

### BRIEF DESCRIPTION OF THE DRAWINGS

In the following, numerous specific details are set forth to provide a thorough description of various embodiments. Certain embodiments may be practiced without these specific details or with some variations in detail. In some instances, certain features are described in less detail so as not to obscure other aspects. The level of detail associated with each of the elements or features should not be construed to qualify the novelty or importance of one feature over the others.

FIG. 1 is a block diagram depicting a schematic representation of a system for automatically creating transition videos, in accordance with one or more exemplary embodiments.

FIG. 2 is a block diagram depicting an embodiment of the video creating module 114 on the computing device, in accordance with one or more exemplary embodiments.

FIG. 3 is a block diagram depicting an embodiment of the automated transitions creating module 116 on the server, in accordance with one or more exemplary embodiments.

FIG. 4 is a flow diagram depicting a method for automatically creating transition videos, in accordance with one or more exemplary embodiments.

FIG. 5 is a flow diagram depicting a method for detecting inflection points in a music track, in accordance with one or more exemplary embodiments.

FIG. 6 is a block diagram illustrating the details of a digital processing system in which various aspects of the present disclosure are operative by execution of appropriate software instructions.

### DETAILED DESCRIPTION OF EXAMPLE EMBODIMENTS

It is to be understood that the present disclosure is not limited in its application to the details of construction and the arrangement of components set forth in the following description or illustrated in the drawings. The present disclosure is capable of other embodiments and of being practiced or of being carried out in various ways. Also, it is to be understood that the phraseology and terminology used herein is for the purpose of description and should not be regarded as limiting.

The use of “including”, “comprising” or “having” and variations thereof herein is meant to encompass the items listed thereafter and equivalents thereof as well as additional items. The terms “a” and “an” herein do not denote a limitation of quantity, but rather denote the presence of at least one of the referenced item. Further, the use of terms “first”, “second”, and “third”, and so forth, herein do not denote any order, quantity, or importance, but rather are used to distinguish one element from another.

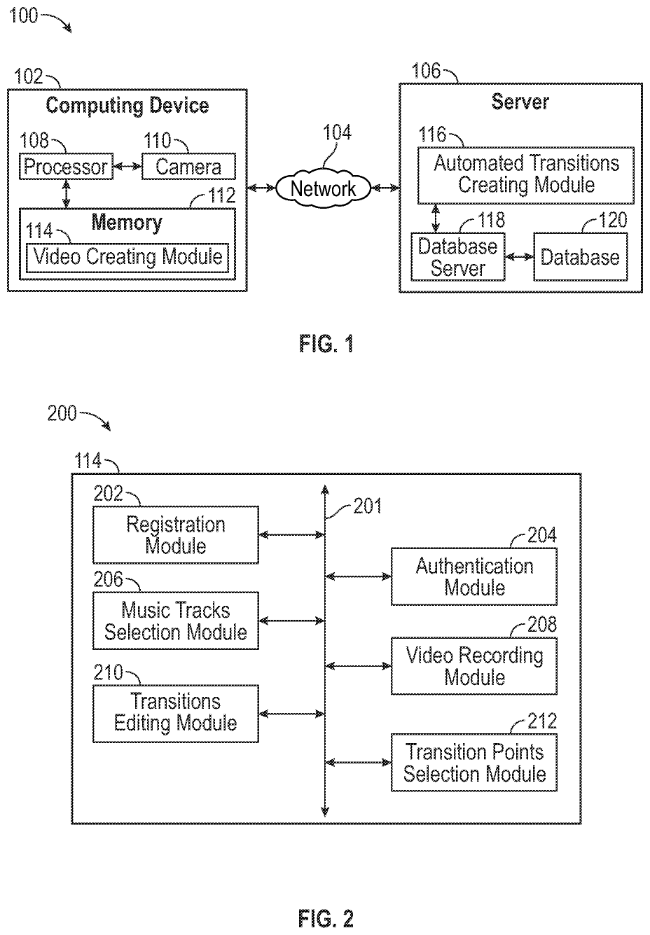

Referring FIG. 1 is a block diagram 100 depicting a schematic representation of a system for automatically creating transition videos, in accordance with one or more exemplary embodiments. The system 100 includes a computing device 102, a network 104, a server 106, a processor 108, a camera 110, a memory 112, a video creating module 114, an automated transitions creating module 116, a database server 118, and a database 120.

The computing device 102 may include user device. The computing device 102 may include, but is not limited to, a personal digital assistant, smartphones, personal computers, a mobile station, computing tablets, a handheld device, an internet enabled calling device, an internet enabled calling software, a telephone, a mobile phone, a digital processing system, and so forth. The computing devices 102 may include the processor 108 in communication with a memory 112. The processor 108 may be a central processing unit. The memory 112 is a combination of flash memory and random-access memory.

The computing device 102 may be communicatively connected to the server 106 via the network 104. The network 104 may include, but not limited to, an Internet of things (IoT network devices), an Ethernet, a wireless local area network (WLAN), or a wide area network (WAN), a Bluetooth low energy network, a ZigBee network, a WIFI communication network e.g., the wireless high speed internet, or a combination of networks, a cellular service such as a 4G (e.g., LTE, mobile WiMAX) or 5G cellular data service, a RFID module, a NFC module, wired cables, such as the world-wide-web based Internet, or other types of networks may include Transport Control Protocol/Internet Protocol (TCP/IP) or device addresses (e.g. network-based MAC addresses, or those provided in a proprietary networking protocol, such as Modbus TCP, or by using appropriate data feeds to obtain data from various web services, including retrieving XML data from an HTTP address, then traversing the XML for a particular node) and so forth without limiting the scope of the present disclosure.

Although the computing device 102 is shown in FIG. 1, an embodiment of the system 100 may support any number of computing devices. The computing device 102 may be operated by the user. The user may include, but not limited to, an individual, a client, an operator, a content creator, and the like. The computing device 102 supported by the system 100 is realized as a computer-implemented or computer-based device having the hardware or firmware, software, and/or processing logic needed to carry out the computer-implemented methodologies described in more detail herein.

In accordance with one or more exemplary embodiments of the present disclosure, the computing device 102 includes the camera 110 may be configured to enable the user to capture the multimedia objects using the processor 108. The multimedia objects may include, but not limited to short videos, videos, looping videos, and the like. The computing devices 102 may include the video creating module 114 in the memory 112.

The video creating module 114 may be configured to enable the user to select music tracks on the computing device 102 to create a video with transitions. The video creating module 114 may also be configured to enable the user to create or record video segments or upload pre-recorded video segments or photos on the computing device. The video creating module 114 may be any suitable applications downloaded from GOOGLE PLAY® (for Google Android devices), Apple Inc.'s APP STORE® (for Apple devices), or any other suitable database. The video creating module 114 may be desktop application which runs on Windows or Linux or any other operating system and may be downloaded from a webpage or a CD/USB stick etc. In some embodiments, the video creating module 114 may be software, firmware, or hardware that is integrated into the computing device 102. The computing devices 102 may present a web page to the user by way of a browser, wherein the webpage comprises a hyper-link may direct the user to uniform resource locator (URL).

The server 106 may include the automated transitions creating module 116, the database server 118, and the database 120. The automated transitions creating module 116 may be configured to detect inflection points on the music track. The automated transitions creating module 116 may also be configured to provide start and stops points corresponding to the transition points on the music track to create automated transition videos. The automated transitions creating module 116 may also be configured to provide server-side functionality via the network 104 to one or more users. The database server 118 may be configured to access the one or more databases. The database 120 may be configured to store user created and recorded videos. The database 120 may also be configured to store interactions between the modules of the video creating module 114, and the automated transitions creating module 116.

In accordance with one or more exemplary embodiments of the present disclosure, the computing device 102 may be configured to establish communication with the server 106 over the network 104. The computing device 102 may include the video creating module 114. The video creating module 114 may be configured to enable the user to access a special icon, thereby redirecting the user to a track screen and displaying one or more music tracks to the user on the track screen. The video creating module 114 may be configured to allow the user to access and select a music track from the one or more music tracks. The video creating module 114 may be configured to transfer the user selected music track to the server 106 over the network 104. may include the automated transitions creating module 116 may be configured to receive the user selected music track. The automated transitions creating module 116 may be configured to perform audio analysis on the user selected music track and detect one or more inflection points, thereby assigning one or more transition points to the user selected music track based on the one or more detected inflection points. The automated transitions creating module 116 may be configured to generate one or more start and stop points corresponding to the one or more transition points on the user selected music track and transfer the user selected music track with the one or more start and stop points to the computing device 114 over the network 104. The video creating module 114 may be configured to receive the user selected music track with the one or more start and stop points and display the one or more start and stop points of the music track to the user on the computing device 102. The video creating module 112 may be configured to enable the user to record one or more video segments at the one or more start and stop points of the music track. The video creating module 114 may be configured to transfer the user recorded one or more video segments to the server 106. The automated transitions creating module 116 may be configured to receive the user recorded one or more video segments and create a transition video by synchronizing the user recorded one or more video segments.

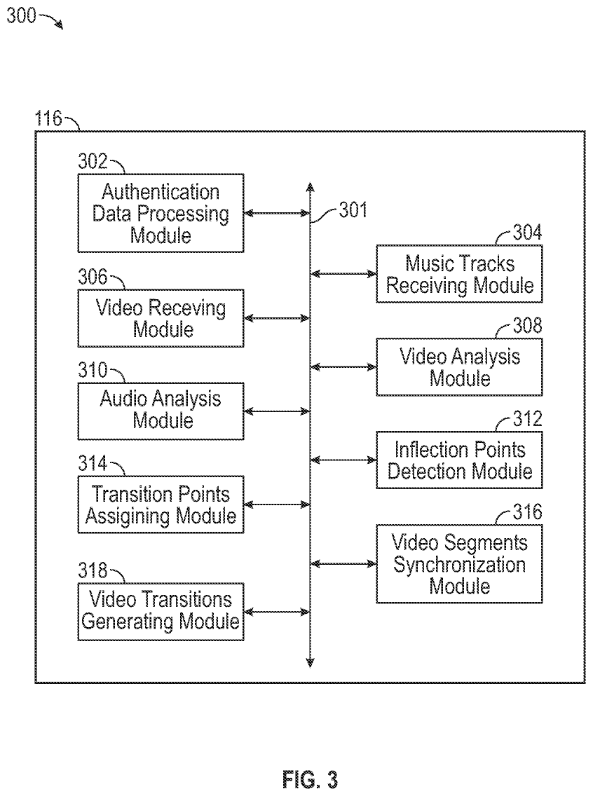

Referring to FIG. 2 is a block diagram 200 depicting an embodiment of the video creating module 114 on the computing device, in accordance with one or more exemplary embodiments. The video creating module 114 includes a bus 201, a registration module 202, an authentication module 204, a music tracks selection module 206, a video recording module 208, a transitions editing module 210, and a transition points selection module 212. The bus 201 may include a path that permits communication among the modules of the content creation module 114 installed on the computing device 102. The term “module” is used broadly herein and refers generally to a program resident in the memory 112 of the computing device 102.

The registration module 202 may be configured to enable the user to register on the video creating module 114 installed on the computing device 102 by providing basic details of the user. The basic details may include but not limited to email, password, first and last name, phone number, address details, and the like. The registration module 202 may also be configured to transfer the user registration details to the server 106 over the network 104. The server 106 may include the automated transitions creating module 116. The automated transitions creating module 116 may be configured to receive the user registration details from the registration module 202. The authentication module 204 may be configured to enable the user to log in and access the video creating module 114 installed on the computing device 102 by using the user login identity credentials. The music tracks selection module 206 may be configured to display the available music tracks on the track screen to the user. The music tracks selection module 206 may also be configured to enable the user to access the music tracks from third-party applications. The music tracks selection module 206 may also be configured to allow the user to access and select the music track for creating or recording the video segments. The music tracks selection module 206 may also be configured to transfer the user selected music track to the server 106 over the network 104. The server 106 may include the automated transitions creating module 116. The automated transitions creating module 116 may be configured to receive the user selected music track.

The video recording module 208 may be configured to enable the user to tap a camera icon on the computing device 102 to record the video segments using the music tracks. The video recording module 208 may also be configured to enable the user to upload pre-recorded videos on the computing device 102. The video recording module 208 may also be configured to enable the user to upload the videos stored from the memory 112 of the computing device 102. The video recording module 208 may also be configured to display the start and stop points of the music track to the user. The video recording module 208 may also be configured to enable the user to record video segments at the start and stop points of the music track. The video recording module 208 may also be configured to transfer the user recorded video segments to the server 106. The video recording module 208 may also be configured to allow the user to record the complete scene corresponding to the entire track duration multiple times. The transitions editing module 210 may be configured to provide an outline of the final frame from the previous video segment for the user to align themselves at the precise point easily and pose to achieve a seamless transition. The transition points selection module 212 may be configured to enable the user to mark their custom transition points on the music track before starting to record the transition videos. The transition points selection module 212 may also be configured to enable the user to mark transition points after recording the video in the case where they record the entire scene multiple times to be used as inputs for the combined transition video.

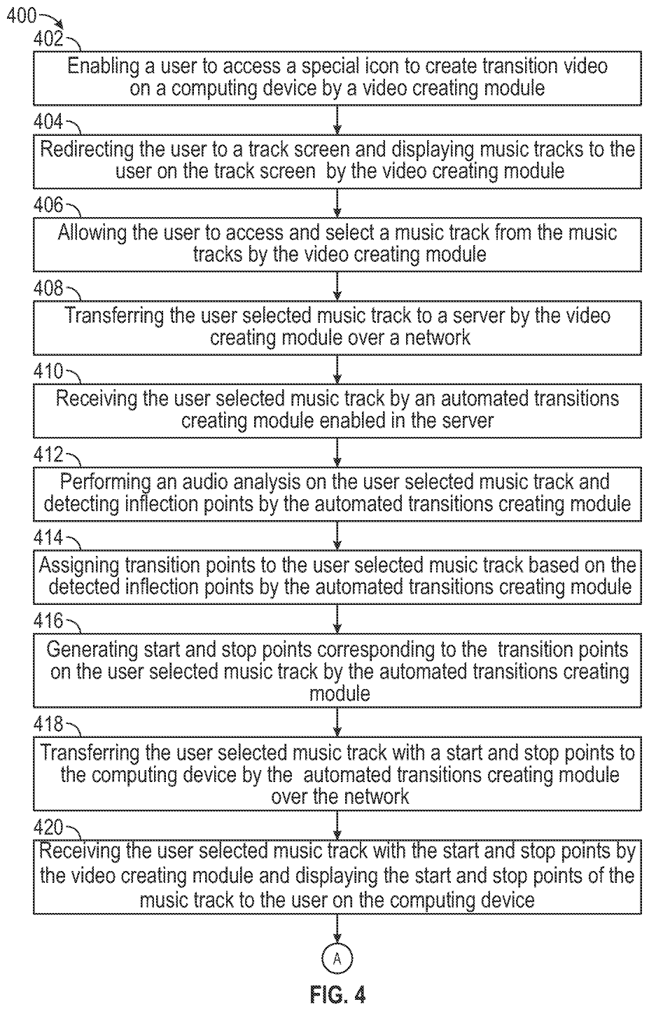

Referring to FIG. 3 is a block diagram depicting an embodiment of the automated transitions creating module 116 on the server, in accordance with one or more exemplary embodiments. The automated transitions creating module 116 include a bus 301, an authentication data processing module 302, a music tracks receiving module 304, a video receiving module 306, a video analysis module 308, an audio analysis module 310, an inflection points detection module 312, a transition points assigning module 314, a video segments synchronization module 316, and a video transitions generating module 318. The bus 301 may include a path that permits communication among the modules of the automated transitions creating module 116 installed on the server 106.

The authentication data processing module 302 may be configured to receive the user registration details from the registration module 202. The authentication data processing module 302 may also be configured to generate the user login identity credentials using the user registration details. The identity credentials comprise a unique identifier (e.g., a username, an email address, a date of birth, a house address, a mobile number, and the like), and a secured code (e.g., a password, a symmetric encryption key, biometric values, a passphrase, and the like). The music tracks receiving module 304 may be configured to receive the user selected music track from the music tracks selection module 206. The audio analysis module 310 may be configured to perform the audio analysis on the user selected music track and detects the changes in the user selected music track. The changes may include but not limited to pace, energy, volume, fusion tracks, and the like. The inflection points detection module 312 may be configured to detect inflection points based on the changes in pace, energy, volume, and fusion tracks of the user selected music track. The transition points assigning module 314 may be configured to assign transition points to the user selected music track based on the detected inflection points. The transition points assigning module 314 may also be configured to generate start and stop points corresponding to the transition points on the user selected music track. The transition points assigning module 314 may also be configured to transfer the user selected music track with the start and stop points to the computing device 102. The video receiving module 306 may be configured to receive the user recorded video segments from the video recording module 204. The video analysis module 308 may be configured to analyze the user recorded video segments to detect objects and points from the user recorded video segments. The video segments synchronization module 316 may be configured to synchronize the user recorded video segments based on the detected objects and points from the user recorded video segments. The video transitions generating module 318 may be configured to stitch the right portions from each video segment to create a transition video. In accordance with one or more exemplary embodiments of the present disclosure, the stop point automatically stops the recording the video at the identified transition points of the music track so that a user may continue recording the video in hands-free mode.

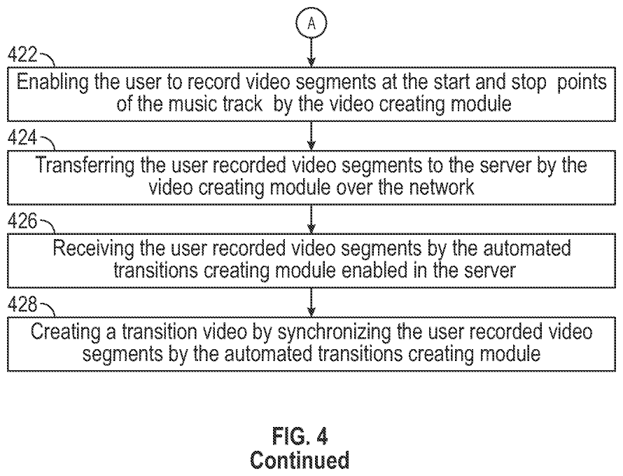

Referring to FIG. 4 is a flow diagram 400 depicting a method for automatically creating transition videos, in accordance with one or more exemplary embodiments. The method 400 may be carried out in the context of the details of FIG. 1, FIG. 2, and FIG. 3. However, the method 400 may also be carried out in any desired environment. Further, the aforementioned definitions may equally apply to the description below.

The method commences at step 402, enabling the user to access a special icon to create transition video on the computing device by the video creating module. Thereafter at step 404, redirecting the user to the track screen and displaying music tracks to the user on the track screen by the video creating module. Thereafter at step 406, allowing the user to access and select the music track from the music tracks by the video creating module. Thereafter at step 408, transferring the user selected music track to the server by the video creating module over a network. Thereafter at step 410, receiving the user selected music track by the automated transitions creating module enabled in the server. Thereafter at step 412, performing the audio analysis on the user selected music track and detecting inflection points by the automated transitions creating module. Thereafter at step 414, assigning transition points to the user selected music track based on the detected inflection points by the automated transitions creating module. Thereafter at step 416, generating start and stop points corresponding to the transition points on the user selected music track by the automated transitions creating module. Thereafter at step 418, transferring the user selected music track with a start and stop points to the computing device by the automated transitions creating module over the network. Thereafter at step 420, receiving the user selected music track with the start and stop points by the video creating module and displaying the start and stop points of the music track to the user on the computing device. Thereafter at step 422, enabling the user to record video segments at the start and stop points of the music track by the video creating module. Thereafter at step 424, transferring the user recorded video segments to the server by the video creating module over the network. Thereafter at step 426, receiving the user recorded video segments by the automated transitions creating module enabled in the server. Thereafter at step 428, creating a transition video by synchronizing the user recorded video segments by the automated transitions creating module.

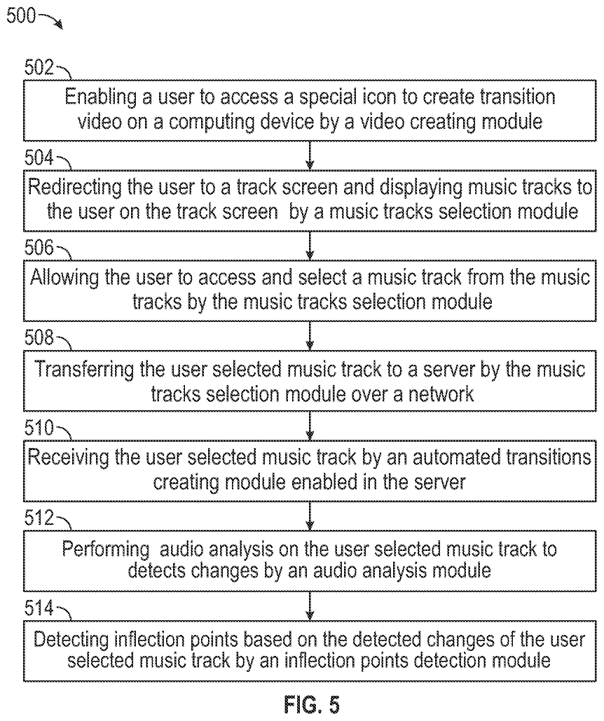

Referring to FIG. 5 is a flow diagram 500 depicting a method for detecting inflection points in a music track, in accordance with one or more exemplary embodiments. The method 500 may be carried out in the context of the details of FIG. 1, FIG. 2, FIG. 3, and FIG. 4. However, the method 500 may also be carried out in any desired environment. Further, the aforementioned definitions may equally apply to the description below.

The method commences at step 502, enabling the user to access the special icon to create transitions video on the computing device by the video creating module. Thereafter at step 504, redirecting the user to the track screen and displaying music tracks to the user on the track screen by the music tracks selection module. Thereafter at step 506, allowing the user to access and select the music track from the music tracks by the music tracks selection module. Thereafter at step 508, transferring the user selected music track to a server by the music tracks selection module over the network. Thereafter at step 510, receiving the user selected music track by an automated transitions creating module enabled in the server. Thereafter at step 512, performing audio analysis on the user selected music track to detect changes by the audio analysis module. Thereafter at step 514, detecting inflection points based on the detected changes of the user selected music track by the inflection points detection module.

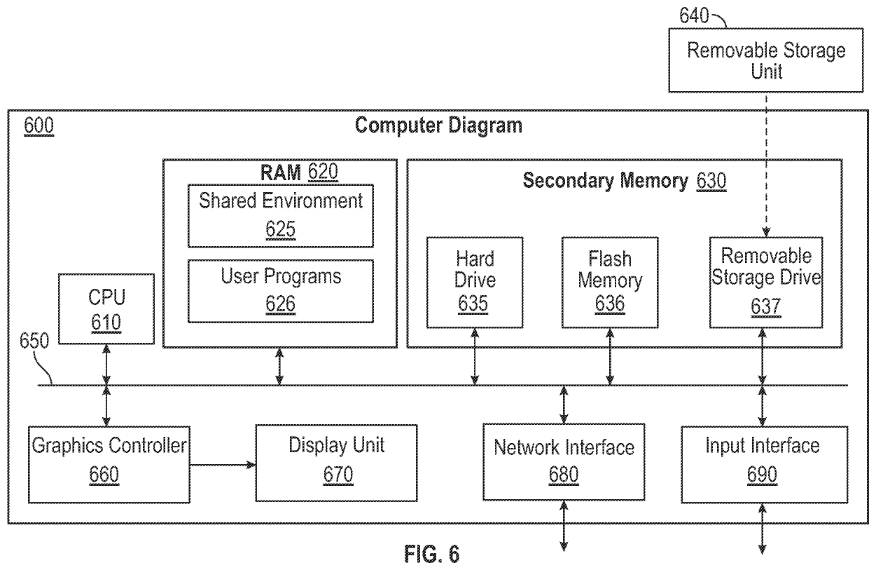

Referring to FIG. 6 is a block diagram 600 illustrating the details of a digital processing system 600 in which various aspects of the present disclosure are operative by execution of appropriate software instructions. The Digital processing system 600 may correspond to the computing device 102 (or any other system in which the various features disclosed above can be implemented).

Digital processing system 600 may contain one or more processors such as a central processing unit (CPU) 610, random access memory (RAM) 620, secondary memory 630, graphics controller 660, display unit 670, network interface 680, and input interface 690. All the components except display unit 670 may communicate with each other over communication path 650, which may contain several buses as is well known in the relevant arts. The components of FIG. 6 are described below in further detail.

CPU 610 may execute instructions stored in RAM 620 to provide several features of the present disclosure. CPU 610 may contain multiple processing units, with each processing unit potentially being designed for a specific task. Alternatively, CPU 610 may contain only a single general-purpose processing unit.

RAM 620 may receive instructions from secondary memory 630 using communication path 650. RAM 620 is shown currently containing software instructions, such as those used in threads and stacks, constituting shared environment 625 and/or user programs 626. Shared environment 625 includes operating systems, device drivers, virtual machines, etc., which provide a (common) run time environment for execution of user programs 626.

Graphics controller 660 generates display signals (e.g., in RGB format) to display unit 670 based on data/instructions received from CPU 610. Display unit 670 contains a display screen to display the images defined by the display signals. Input interface 690 may correspond to a keyboard and a pointing device (e.g., touch-pad, mouse) and may be used to provide inputs. Network interface 680 provides connectivity to a network (e.g., using Internet Protocol), and may be used to communicate with other systems (such as those shown in FIG. 1) connected to the network 104.

Secondary memory 630 may contain hard drive 635, flash memory 636, and removable storage drive 637. Secondary memory 630 may store the data software instructions (e.g., for performing the actions noted above with respect to the Figures), which enable digital processing system 600 to provide several features in accordance with the present disclosure.

Some or all of the data and instructions may be provided on removable storage unit 640, and the data and instructions may be read and provided by removable storage drive 637 to CPU 610. Floppy drive, magnetic tape drive, CD-ROM drive, DVD Drive, Flash memory, removable memory chip (PCMCIA Card, EEPROM) are examples of such removable storage drive 637.

Removable storage unit 640 may be implemented using medium and storage format compatible with removable storage drive 637 such that removable storage drive 637 can read the data and instructions. Thus, removable storage unit 640 includes a computer readable (storage) medium having stored therein computer software and/or data. However, the computer (or machine, in general) readable medium can be in other forms (e.g., non-removable, random access, etc.).

In this document, the term “computer program product” is used to generally refer to removable storage unit 640 or hard disk installed in hard drive 635. These computer program products are means for providing software to digital processing system 600. CPU 610 may retrieve the software instructions, and execute the instructions to provide various features of the present disclosure described above.

The term “storage media/medium” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage memory 630. Volatile media includes dynamic memory, such as RAM 620. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus (communication path) 650. Transmission media can also take the form of acoustic or light waves, such as those generated during radio-wave and infra-red data communications.

According to an exemplary aspect of the present disclosure, enabling a user to access a special icon to create one or more transition videos on a computing device by a video creating module.

According to an exemplary aspect of the present disclosure, redirecting the user to a track screen and displaying one or more music tracks to the user on the track screen by the video creating module 114.

According to an exemplary aspect of the present disclosure, allowing the user to access and select a music track from the one or more music tracks by the video creating module 114.

According to an exemplary aspect of the present disclosure, transferring the user selected music track to a server 106 by the video creating module 114 over a network 104.

According to an exemplary aspect of the present disclosure, receiving the user selected music track by an automated transitions creating module 116 enabled in the server 106.

According to an exemplary aspect of the present disclosure, performing an audio analysis on the user selected music track and detecting one or more inflection points by the automated transitions creating module 116.

According to an exemplary aspect of the present disclosure, assigning one or more transition points to the user selected music track based on the one or more detected inflection points by the automated transitions creating module 116.

According to an exemplary aspect of the present disclosure, generating one or more start and stop points corresponding to the one or more transition points on the user selected music track by the automated transitions creating module 116.

According to an exemplary aspect of the present disclosure, transferring the user selected music track with the one or more start and stop points to the computing device by the automated transitions creating module 116 over the network 104.

According to an exemplary aspect of the present disclosure, receiving the user selected music track with the one or more start and stop points by the video creating module 114 and displaying the one or more start and stop points of the music track to the user on the computing device 102.

According to an exemplary aspect of the present disclosure, enabling the user to record one or more video segments at the one or more start and stop points of the music track by the video creating module 114.

According to an exemplary aspect of the present disclosure, transferring the user recorded one or more video segments to the server by the video creating module 114 over the network 104.

According to an exemplary aspect of the present disclosure, receiving the user recorded one or more video segments by the automated transitions creating module 116 enabled in the server 106.

According to an exemplary aspect of the present disclosure, creating a transition video by synchronizing the user recorded one or more video segments by the automated transitions creating module 116.

Reference throughout this specification to “one embodiment”, “an embodiment”, or similar language means that a particular feature, structure, or characteristic described in connection with the embodiment is included in at least one embodiment of the present disclosure. Thus, appearances of the phrases “in one embodiment”, “in an embodiment” and similar language throughout this specification may, but do not necessarily, all refer to the same embodiment.

Furthermore, the described features, structures, or characteristics of the disclosure may be combined in any suitable manner in one or more embodiments. In the above description, numerous specific details are provided such as examples of programming, software modules, user selections, network transactions, database queries, database structures, hardware modules, hardware circuits, hardware chips, etc., to provide a thorough understanding of embodiments of the disclosure.

Although the present disclosure has been described in terms of certain preferred embodiments and illustrations thereof, other embodiments and modifications to preferred embodiments may be possible that are within the principles and spirit of the invention. The above descriptions and figures are therefore to be regarded as illustrative and not restrictive.

Thus the scope of the present disclosure is defined by the appended claims and includes both combinations and sub-combinations of the various features described hereinabove as well as variations and modifications thereof, which would occur to persons skilled in the art upon reading the foregoing description.

What is claimed is:

1. A method for automatically creating transition videos, comprising:
enabling a user to access a special icon to create one or more transition videos on a computing device by a video creating module;
redirecting the user to a track screen and displaying one or more music tracks to the user on the track screen by the video creating module;
allowing the user to access and select a music track from the one or more music tracks by the video creating module;
transferring the user selected music track to a server by the video creating module over a network;
receiving the user selected music track by an automated transitions creating module enabled in the server;
performing an audio analysis on the user selected music track and detecting one or more inflection points by the automated transitions creating module;
assigning one or more transition points to the user selected music track based on the one or more detected inflection points by the automated transitions creating module;
generating one or more start and stop points corresponding to the one or more transition points on the user selected music track by the automated transitions creating module;
transferring the user selected music track with the one or more start and stop points to the computing device by the automated transitions creating module over the network;
receiving the user selected music track with the one or more start and stop points by the video creating module and displaying the one or more start and stop points of the music track to the user on the computing device;
enabling the user to record one or more video segments at the one or more start and stop points of the music track by the video creating module;
transferring the user recorded one or more video segments to the server by the video creating module over the network;
receiving the user recorded one or more video segments by the automated transitions creating module enabled in the server; and
creating a transition video by synchronizing the user recorded one or more video segments by the automated transitions creating module.

2. The method of claim 1, comprising a step of displaying the one or more music tracks on the track screen after the user is redirected to the track screen by a music tracks selection module.

3. The method of claim 1, comprising a step of allowing the user to access and select the music track from the one or more music tracks by the music tracks selection module.

4. The method of claim 1, comprising a step of transferring the user selected music track to the server by the music tracks selection module.

5. The method of claim 1, comprising a step of receiving the user selected music track from the music tracks selection module by a music tracks receiving module.

6. The method of claim 1, comprising a step of performing the audio analysis on the user selected music track and detecting the changes in the user selected music track by an audio analysis module.

7. The method of claim 1, comprising a step of detecting the one or more inflection points based on the changes in the user selected music track by an inflection points detection module.

8. The method of claim 1, comprising a step of assigning one or more transition points to the user selected music track based on the detected inflection points by a transition points assigning module.

9. The method of claim 1, comprising a step of generating the one or more start and stop points corresponding to the one or more transition points on the user selected music track by the transition points assigning module.

10. The method of claim 1, comprising a step of transferring the user selected music track with the one or more start and stop points to the computing device by the transition points assigning module.

11. The method of claim 1, comprising a step of displaying the one or more start and stop points of the music track to the user by a video recording module.

12. The method of claim 1, comprising a step of enabling the user to record one or more video segments at the one or more start and stop points of the music track by the video recording module.

13. The method of claim 1, comprising a step of transferring the user recorded one or more video segments to the server by the video recording module.

14. The method of claim 1, comprising a step of analyzing the user recorded one or more video segments to detect objects and points by a video analysis module.

15. The method of claim 1, comprising a step of synchronizing the user recorded one or more video segments based on the detected objects and points by a video segments synchronization module.

16. The method of claim 1, comprising a step of stitching one or more right portions of the user recorded one or more video segments by a video transitions generating module.

17. The method of claim 1, comprising a step of enabling the user to mark their custom transition points on the music track before starting to record the transition videos by a transition points selection module.

18. The method of claim 1, comprising a step of allowing the user to record the complete scene corresponding to the entire music track duration multiple times.

19. A system for automatically creating transition videos, comprising:
a computing device configured to establish communication with a server over a network, whereby the computing device comprises a video creating module configured to enable a user to access a special icon, thereby redirecting the user to a track screen and displaying one or more music tracks to the user on the track screen, the video creating module configured to allow the user to access and select a music track from the one or more music tracks, the video creating module configured to transfer the user selected music track to the server over the network;
the server comprising an automated transitions creating module configured to receive the user selected music track, whereby the automated transitions creating module configured to perform audio analysis on the user selected music track and detect one or more inflection points, thereby assigning one or more transition points to the user selected music track based on the one or more detected inflection points, the automated transitions creating module configured to generate one or more start and stop points corresponding to the one or more transition points on the user selected music track and transfer the user selected music track with the one or more start and stop points to the computing device over the network;
the video creating module configured to receive the user selected music track with the one or more start and stop points and display the one or more start and stop points of the music track to the user on the computing device, the video creating module configured to enable the user to record one or more video segments at the one or more start and stop points of the music track, wherein the video creating module configured to transfer the user recorded one or more video segments to the server; and
the automated transitions creating module configured to receive the user recorded one or more video segments and create a transition video by synchronizing the user recorded one or more video segments.

20. A computer program product comprising a non-transitory computer-readable medium having a computer-readable program code embodied therein to be executed by one or more processors, said program code including instructions to:
enable a user to access a special icon to create one or more transition videos on a computing device by a video creating module;
redirect the user to a track screen and display one or more music tracks to the user on the track screen by the video creating module;
allow the user to access and select a music track from the one or more music tracks by the video creating module;
transfer the user selected music track to a server by the video creating module over a network;
receive the user selected music track by an automated transitions creating module enabled in the server;
perform an audio analysis on the user selected music track and detect one or more inflection points by the automated transitions creating module;
assign one or more transition points to the user selected music track based on the one or more detected inflection points by the automated transitions creating module;
generate one or more start and stop points corresponding to the one or more transition points on the user selected music track by the automated transitions creating module;
transfer the user selected music track with the one or more start and stop points to the computing device by the automated transitions creating module over the network;
receive the user selected music track with the one or more start and stop points by the video creating module and display the one or more start and stop points of the music track to the user on the computing device;
enable the user to record one or more video segments at the one or more start and stop points of the music track by the video creating module;
transfer the user recorded one or more video segments to the server by the video creating module over the network;
receive the user recorded one or more video segments by the automated transitions creating module enabled in the server; and
create a transition video by synchronizing the user recorded one or more video segments by the automated transitions creating module.
